(19) United States
(12) Patent Application Publication
(10) Pub. No.: US 2017/0339835 A1
(43) Pub. Date: Nov. 30, 2017

(54) PLANT SURROUND

(71) Applicants: Brian John Measday, Myrtle Bank (AU); Mario Rene Niesingh, Myrtle Bank (AU)

(72) Inventors: Brian John Measday, Myrtle Bank (AU); Mario Rene Niesingh, Myrtle Bank (AU)

(21) Appl. No.: 15/599,643

(22) Filed: May 19, 2017

(30) Foreign Application Priority Data
May 30, 2016 (AU) 2016902043

(51) Int. Cl. A01G 1/08; A01G 9/02; A01G 25/02; A01G 13/02

(52) U.S. Cl. CPC A01G 1/08; A01G 9/022; A01G 9/02; A01G 25/02; A01G 13/0243

(57) ABSTRACT

In one aspect of the invention there is provided a plant surround for forming a water retaining barrier around a plant, including a curved generally elongate body having opposing ends including cooperating engagement members that are configured to reversibly engage to thereby delineate said water retaining barrier and a locking member attached to said elongate body and configured to inhibit complete or partial disengagement of said opposing ends of the body. In other aspects, there is provided a biodegradable plant surround and a plant surround including irrigation hose engaging tabs.

### FIELD OF THE INVENTION

The present invention relates generally to a surround for a plant and in particular to a tree surround for directing water into the root zone of the tree.

### BACKGROUND OF THE INVENTION

There are various water retaining surrounds for trees disclosed in the prior art, including the surround described in U.S. Pat. No. 5,566,503 to Nickson, which comprises a water-retaining enclosure that can be placed around a tree wherein opposite end portions of the wall are secured together.

Another water retaining surround is disclosed in PCT Application WO98/34469 to the present inventors, which is hereby incorporated by reference. The inventors' earlier patent discloses a plant surround comprised of a circular moulding of plastics material which is discontinuous, and has interfering surfaces between opposing ends of the discontinuous shape. The surfaces at the respective opposing ends being slidable along a longitudinal alignment to affect an interlocking joining between the ends to provide a water retaining void.

There are however issues with the existing plant surrounds on the market. For instance, since the lower portion of the plant surround is typically buried in the soil with a soil level within the surround typically lower than the surrounding ground surface, a pressure differential is created between the soil side of the surround and the inner side of the surround. Movement or warping of the plant surround can occur due to such forces as hydrostatic pressure and soil pressure. This can result in the opposing ends, which are slidable relative to each other, moving out of alignment longitudinally along the join. Accordingly, the water retaining integrity of the plant surround is then affected and the raised end can create a safety hazard to persons in the vicinity.

Another issue with currently available surrounds is the provision of water using irrigation hoses and pipes. Typically, the plant surround is simply filled with water at regular intervals, which is then allowed to penetrate into the soil body. However, there are circumstances where additional watering or semi-permanent watering is required. This can be undertaken using a conventional irrigation hose and dripper or spay device. Since the plant surround, once installed, creates a continuous wall around the plant the irrigation hose is often simply hung over the side of the plant surround. Accordingly, it can be easily dislodged and the dripper or spay device can fall outside the plant surround thereby severely affecting it usefulness. It is known that some users drill holes through a side of the plant surround to pass the irrigation pipe therethrough, however this adversely affects the structural integrity of the plant surround and its water holding capacity.

It has also been found that the use of the currently available plant surrounds can cause the roots of the plant to travel around the inner surface of the surround thereby causing girdling that can adversely affect the vigour or health of the plant. This is particularly the case with plants during early establishment.

Finally, existing plant surrounds have to be removed after a period of time, due to the size of the tree or once the plant has become established and no longer requires additional watering. Furthermore, the plant surrounds can become damaged due to effects of UV light or due to physical impact. This is particularly the case where government agencies and councils use the plant surrounds in the establishment of street trees. Accordingly, this requires further expenditure in remove of the infrastructure when it is no longer required.

The present invention is therefore provided to ameliorate at least some of these problems or to provide a useful alternative. It should be appreciated that any discussion of the prior art throughout the specification is included solely for the purpose of providing a context for the present invention and should in no way be considered as an admission that such prior art was widely known or formed part of the common general knowledge in the field as it existed before the priority date of the application.

### SUMMARY OF THE INVENTION

In one aspect of the invention, but not necessarily the broadest or only aspect, there is proposed a plant surround including: a curved generally elongate body having opposing ends including cooperating engagement members that are configured to reversibly engage to thereby delineate a water retaining barrier; and a locking member attached to said elongate body and configured to inhibit complete or partial disengagement of said opposing ends of the body.

The plant surround may be moulded from a plastics material and has a generally circular shape. In other forms the plant surround may have an elongate, square or rectangular shape.

In one form the body may be generally rectangular shaped and curved such that the shorter edge of the body form said opposing ends. A lower edge of the body may be configured to engage a soil surface surrounding the plant and the upper edge of the body extends above a soil surface. The lower edge may include scallops or an irregular surface to assist in securing the plant surround into the soil.

The opposing ends of the elongate body are slidable along their respective longitudinal alignment to affect an interconnecting joining between said opposing ends to form a water retaining void.

The opposing ends are slidable in a first direction to affect connection thereof to form said water retaining barrier and slidable in a second direction being opposite to said first direction to disconnect said opposing ends to enable the placement or removal of the plant surround around a plant.

A first opposing end of the body may include a protrusion to terminate movement of a second opposing end of the body in said first direction, to thereby locate adjacent portions of the upper edge generally along the same horizontal plane.

Preferably the protrusion is located on, or adjacent, the upper edge of the body, whereby when the adjacent portions of the upper edge of the body are positioned along the same horizontal plane the opposing ends are fully engaged.

The locking member inhibits the opposing ends from moving in said second direction out of the fully engaged position. Preferably the locking member slidably engages the elongate body and is configured to slide along an axis that is perpendicular to the longitudinal alignment of the cooperating opposing ends.

In one form the locking member is moved from an unlocked position where it is at a distance from a longitudinal axis of the cooperating opposing ends, and a locked position wherein the locking member intersects said longitudinal axis to thereby inhibit the cooperating opposing ends from disengaging.

The locking member preferably engages a lip that extends circumferentially around said upper edge of the body. The locking member may be curved to conform to the shape of the body and the upper edge may include a raised portion to frictionally engage the locking member when in the locked position to inhibit the accidental movement of the locking member out of said locked position.

The locking member may be provided separately or joined to the body and can be removed and clipped over the lip prior to installation by a user. In this way, the stackability of the plant surround with other plant surrounds is not affected by having the locking member already attached. The configuration of the locking member and body also means that it is held in place under normal circumstances but can be moved to be unlocked to allow removal of the plant surround from around the plant or tree.

The locking member may be detachably joined to the lip and positioned inwardly of the upper edge of the body. In one form the locking member is connected to the body by a spline before installation and can be broken off by a user for use thereof. The location of the locking member means that the ability to stack multiple plant surrounds is not impeded and each individual plant surround can be injection moulded at a single time.

Once in position around the tree the opposing ends are slide along their respective longitudinal alignment to affect an interconnecting. Once the second opposing end of the body abuts with the protrusion of the first opposing end the locking member is slid from the unlocked to the locked position to inhibit the cooperating opposing ends from disengaging.

Accordingly, in one aspect the plant surround comprised of a circular moulding of plastics material which is discontinuous, and has interfering surfaces between opposing ends of the discontinuous shape which define a discontinuous zone, the surfaces at the respective ends being relatively slidable along their respective longitudinal alignment to affect an interlocking joining between the ends to provide a water retaining barrier.

In another aspect of the invention there is proposed a plant surround comprising a plurality of interconnecting body portions, each body portion including opposite ends including engagement members wherein each body portion reversibly engageable with an adjacent body portions to thereby delineate a water retaining barrier that extends around a plant.

In still another aspect of the invention there is proposed a plant surround for a plant, including a body that is configured to extend around said plant, wherein an inner surface of the body includes ridges or grooves to inhibit girdling of roots of the plant when the plant surround is positioned within a soil body.

The immediately preceding aspect wherein the body may be constructed from a single generally circular elongate member having ends that are configured to cooperatively engage or the body is constructed from a plurality of portions that cooperate to surround the tree or plant.

In yet still another aspect of the invention there is proposed a plant surround for a plant, including a body that is configured to extend around said plant to provide a water retaining barrier; and at least one tab extending inwardly of the plant surround, the tab being configured to retain a length of irrigation hose to thereby direct an outlet of said irrigation hose inwardly of the water retaining barrier.

Preferably a first tab is positioned a first side of the plant surround and a second tab is positioned on a second side of the plant surround. Both the first and second tabs are configured to extend inwardly into the void created by the body. The tab or tabs may extend inwardly of the lip that extends circumferentially around said upper edge of the body. The position of the tabs means that they do not affected the stacking of multiple plant surrounds. The tabs on either side also mean that the irrigation hose can be secured as it enters and exist the void created by the body.

The tab or tabs may include a line of weakness that means that they can be detached from the body if not required.

The tab or tabs preferably include an aperture that is configured to hold the flexible irrigation tube. The aperture may be between 2 mm-10 mm in diameter and may frictionally engage an irrigation hose. The tabs may alternatively include a sidewardly open slot or may have a generally S-shape configuration to hold the irrigation pipe.

In a further aspect of the invention there is proposed a plant surround for a plant, including a body that is configured to extend around said plant to provide a water retaining barrier, wherein the body is constructed from a biodegradable material.

The terms biodegradable and biodegradation used throughout the specification should be understood to encompass all forms of disintegration of the material and includes oxo-degradation, UV-degradation and/or biological degradation by microorganisms.

Accordingly, there may be provided a discontinuous plant surround for a plant including opposing ends that are configured to cooperate to thereby delineate a water retaining barrier extending around said plant, wherein the plant surround is constructed from a biodegradable plastic material having a known life span range within an environment. Accordingly, after a predetermined period of time the plant surround will degrade or breakdown within the environment.

The life span of the plant surround may be selected from a group including, but not limited to, two years, three years, four year, five years and six years. The life span of the plant surround may vary depending upon the environment and may be affected by climatic and biological conditions, including soil moisture, humidity, soil acidity, level of UV radiation and soil fauna. Accordingly, the predetermined period of time may be within a range of months or years.

The plant surround may include indicia to indicate the time of manufacture and the period of time over which the plant surround will degrade or breakdown within the environment. The indicia may also indicate if the plant surround is constructed from a non-biodegradable material or a biodegradable material.

### BRIEF DESCRIPTION OF THE DRAWINGS

The accompanying drawings, which are incorporated in and constitute a part of this specification, illustrate an implementation of the invention and, together with the description and claims, serve to explain the advantages and principles of the invention. In the drawings,

FIG. 1 is a perspective view of one embodiment of the plant surround of the present invention installed around a tree;

FIG. 2 is a side view the plant surround of FIG. 1 illustrating the lower edge;

FIG. 3 is a perspective view of the plant surround of FIG. 1 having opposing ends in a disengaged position;

FIG. 4 is a perspective view of the plant surround of FIG. 3 illustrating the warping of the opposing ends to facilitate slidable engagement thereof;

FIG. 5 is a perspective view of the plant surround of FIG. 4 illustrating the full engagement of opposing ends and movement of the locking member;

FIG. 6a is a top view of the locking member detached from the plant surround;

FIG. 6b is an underside view of the locking member of FIG. 6a;

FIG. 7a is a partial top view of the plant surround with locking member attached;

FIG. 7b is a partial underside view of the plant surround of FIG. 7a;

FIG. 8a is a perspective view of the plant surround as at the point of purchase with the locking member detachably connected to the body by a spline;

FIG. 8b is an underside view of the plant surround of FIG. 8a;

FIG. 8c is a top view of the plant surround of FIG. 8a;

FIG. 9 is a perspective view of the plant surround illustrating the engagement of a length of irrigation hose with the tabs;

FIG. 10 is a perspective view of another embodiment of the plant surround, comprising three portions;

FIG. 11 is a graph illustrating the results of biodegradability testing through 32 weeks of thermal testing;

FIG. 12a is a perspective view of a biodegradable plant surround in an early stage of biodegradation;

FIG. 12b is a perspective view illustrating the biodegradable plant surround having fully degraded in situ; and

FIG. 13 is a top view of the upper lip of the plant surround showing indicia used to display relevant information relating to the biodegradable plant surround.

### DETAILED DESCRIPTION

Similar reference characters indicate corresponding parts throughout the drawings. Dimensions of certain parts shown in the drawings may have been modified and/or exaggerated for the purposes of clarity or illustration.

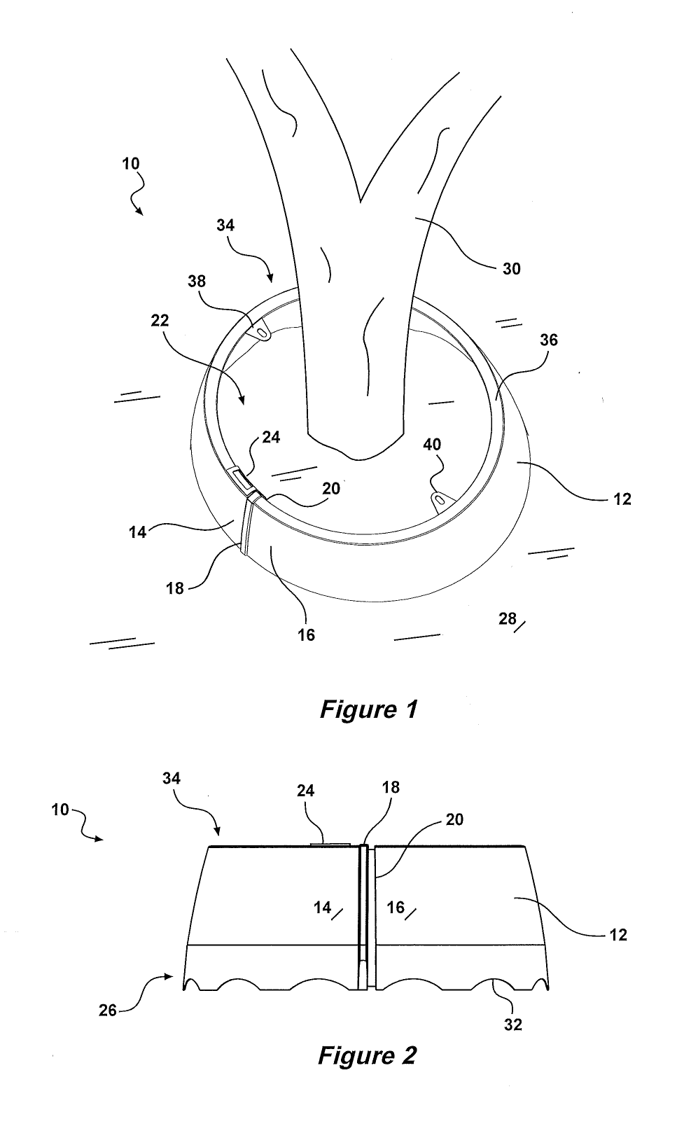

Referring to the drawings for a more detailed description, a plant surround 10 is illustrated, demonstrating by way of examples, arrangements in which the principles of the present invention may be employed. In one embodiment as illustrated in FIGS. 1 and 2, the generally circular moulded plastics plant surround 10 includes a curved generally elongate body 12 having opposing ends 14, 16 with cooperating engagement members 18, 20 that are configured to reversibly engage to thereby delineate a water retaining barrier enclosing a water receiving void 22. A locking member 24 is attached to the elongate body 12 and configured to inhibit complete or partial disengagement of the opposing ends 14, 16 of the body 12.

The body 12 is generally rectangular shaped and curved such that the shorter edges of the body form the opposing ends 14, 16. A lower edge 26 of the body 12 is configured to engage a soil 28 surrounding a plant or tree 30. The lower edge 26 may include scallops or a curved edge 32 to assist with the installation of the plant surround 10. The upper edge 34 of the body 12 extends above the surface of the soil 28 and includes a lip 36 to which the locking member 24 is slidably engaged.

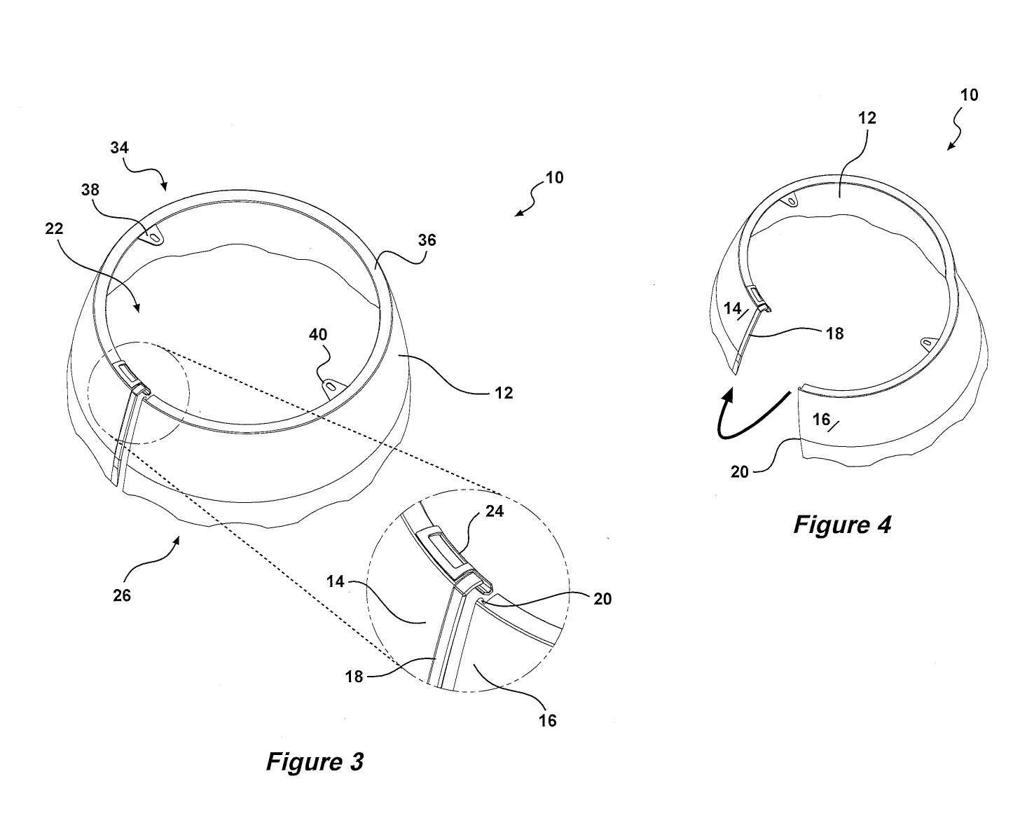

As illustrated in FIGS. 3 to 5, the engagement members 18, 20 of the elongate body 12 are slidable along their respective longitudinal alignment to affect an interconnecting joining between the opposing ends 14, 16 to delineate the water retaining barrier.

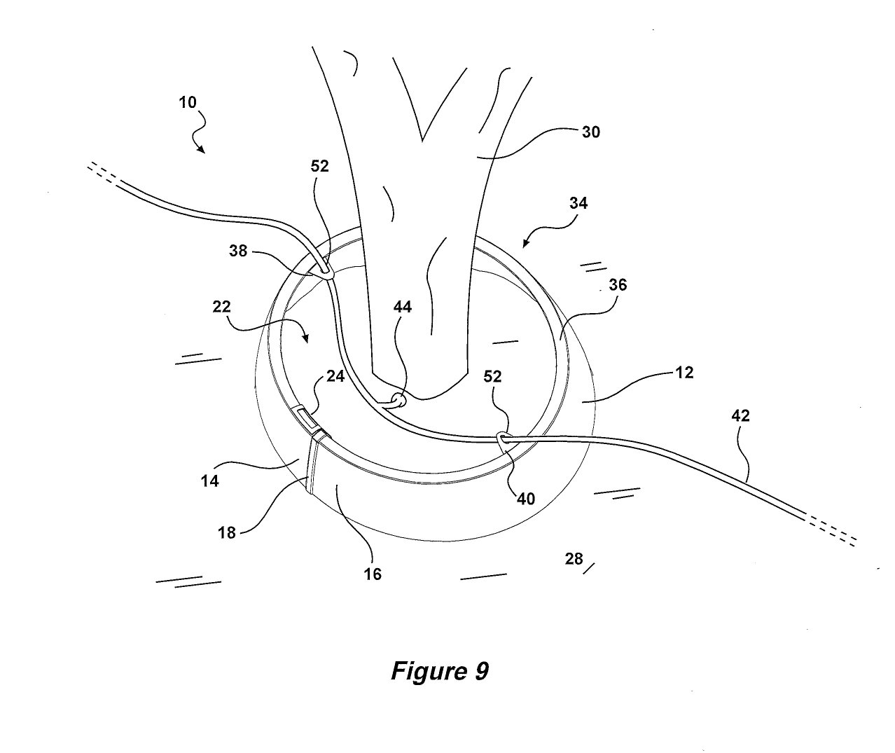

Tabs 38, 40 extend inwardly of the plant surround 10 and are configured to retain a length of irrigation hose 42 to thereby direct an outlet 44 of the irrigation hose 42 inwardly of the water retaining barrier, as will be discussed further in relation to FIG. 9.

Once in position around the tree the opposing ends 14, 16 are slide along their respective longitudinal alignment to affect an interconnecting. As illustrated in FIG. 4, the opposing end 14 is slid in a first direction, as indicated by the arrow to connect the opposing ends 14, 16 to form the water retaining barrier.

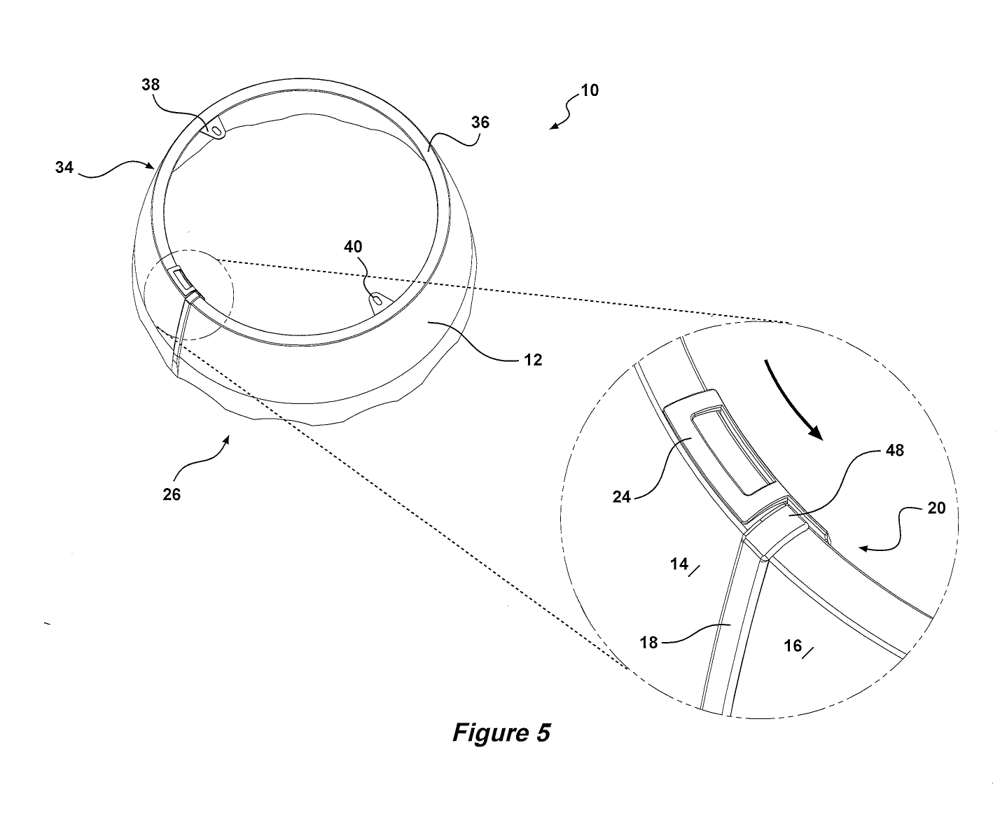

End 16 of the body 12 including a protrusion 48 that is used to terminate movement of end 14 in the first direction, to thereby locate adjacent portions of the upper edge 34 along the same horizontal plane, as illustrated in FIG. 5.

Once the upper edge 34 of end 14 abuts with the protrusion 48 of end 16 the locking member 24, which is connected to lip 36, is slid from the unlocked position as illustrated in FIG. 7a, into the locked position as illustrated in FIG. 5, to thereby inhibit the cooperating opposing ends 14, 16 from disengaging.

The locking member 24 inhibits the opposing ends from moving relative to each other and out of the fully engaged position, as illustrated in FIG. 5. The locking member 24 slides along an axis that is generally perpendicular to the engagement members 18, 20, as indicated by the arrow in FIG. 5.

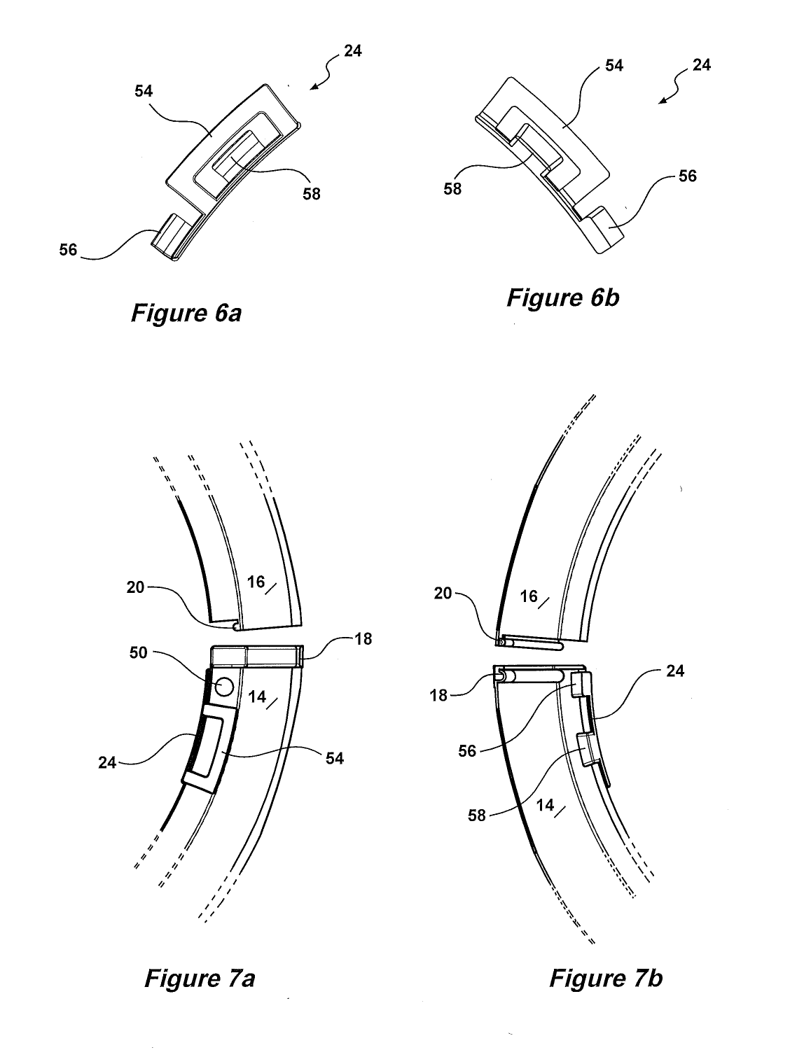

FIGS. 6a to 7b illustrate the locking member 24 that includes an upper plate 54 that can be used by the user to move the locking member 24, and depending leg portions 56, 58 that are configured to engage lip 36. The upper edge 34 includes a raised portion 50, as illustrated in FIG. 7a to frictionally engage the locking member 24 when in the locked position to inhibit the accidental movement of the locking member 24 out of said locked position.

To remove the plant surround 10 from around the tree 30 the locking member 24 is moved into the unlocked position, which allows the ends 14, 16 to move relative to each other and thereby allow them to be disengaged from each other.

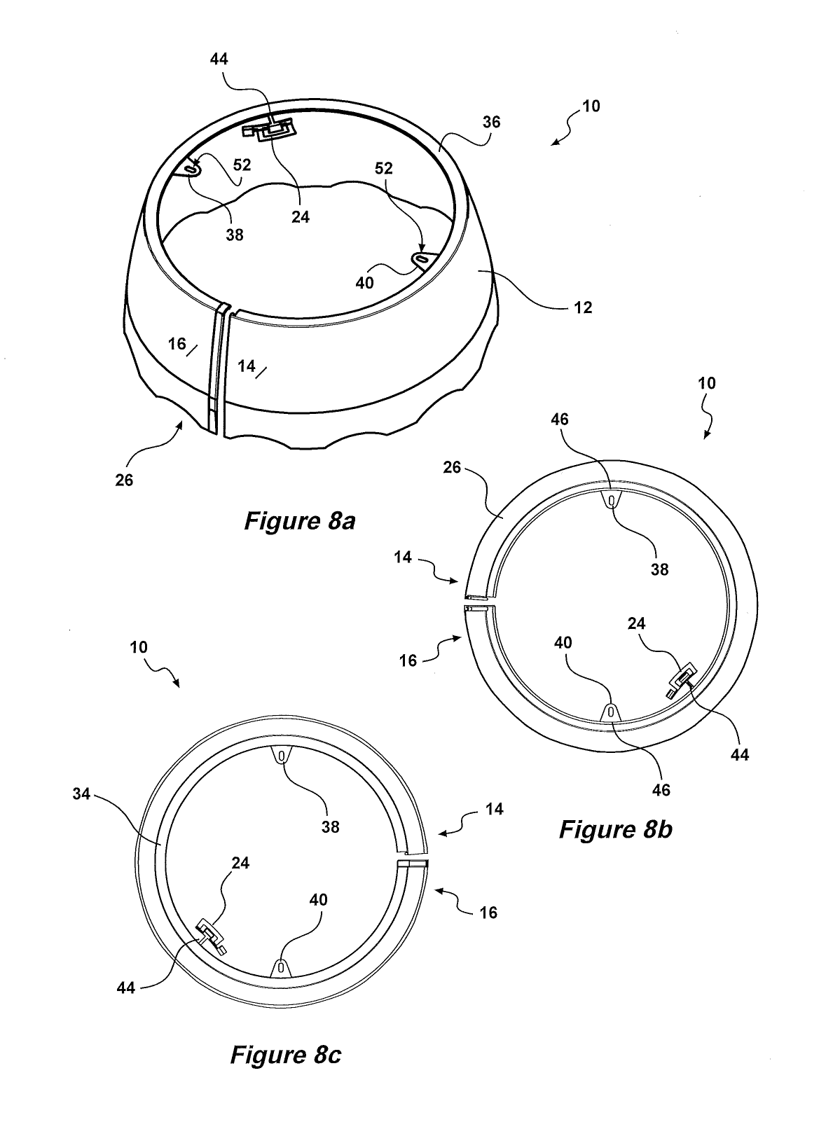

As illustrated in FIGS. 8a to 8c, the locking member 24 is detachably connected to the body 12 by a spline 44 when the plant surround 10 prior to installation around a tree or plant. The location of the locking member 24 means that the ability to stack of the product is not restricted and the whole product can be injection moulded at a single time. The locking member 24 can then be broken off by a user and attached to the lip 36 at the site where it is to be installed.

As illustrated in FIG. 9 the plant surround includes tabs 38, 40 that are configured to retain a length of irrigation hose 42. In the present embodiment, the outlet is a dripper 44 that is connected to the irrigation hose 42 and is used to irrigate the plant 30.

As illustrated in FIG. 8b the tabs 38, 40 each includes a line of weakness 46 which means that they can be broken or cut off the body 12 if not required.

Turning back to FIG. 9, the tabs 38, 40 are positioned on either side of the plant surround 10 so that the irrigation hose 42 is secured as it enters and exist the water receiving void 22 created by the body 12. The tabs 38, 40 extend inwardly of the void created by the body to thereby not affect the stackability of the plant surround 10 when multiple plant surrounds are being transported.

As further illustrated in FIG. 9 the tabs 38, 40 include an aperture 52 that is configured to engage and hold the flexible irrigation hose 42. The irrigation hose 42 is passed through the aperture 52 and then the dripper 44 is connected. In this way the irrigation tube 42 slidably engages through the apertures 52. Alternatively, the apertures 52 may frictionally engage the hose 42 or the tabs 38, 40 may be sidewardly open.

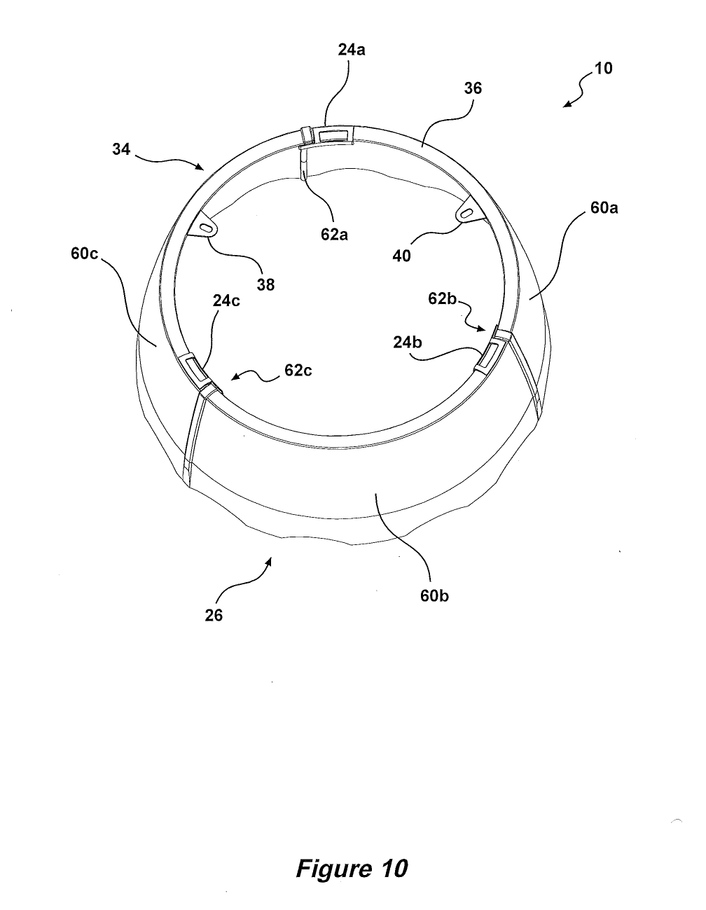

FIG. 10 illustrates a plant surround 10 comprising a plurality of interconnecting body portions 60a, 60b, 60c. Each of the body portions 60a, 60b, 60c reversibly engageable with an adjacent body portion to thereby delineate the water retaining barrier that extends around the plant.

FIG. 10 also illustrates the position of the ridges 62a, 62b, 62c that are configured to inhibit girdling of roots of the plant when the plant surround 10 is positioned within the soil 28. The reader should however appreciate that the ridges may be replaced with grooves and the ridges or grooves may extend down the inner surface of a plant surround comprising a single body portion 12, as previously illustrated.

In another embodiment, the plant surround 10 is constructed from a biodegradable material. Testing of a biodegradable plant surround 10 has been undertaken on behalf of the Applicant to determine the degradation properties of the biodegradable plant surround 10. Each of the samples tested included an additive obtained from Willow Ridge Plastics, Inc. (WRP). The WRP additive, hereafter referred to as PDQ-M, contains a trace element at a known concentration. When tested the ratios were expected to remain proportional and therefore the additive concentration loading rate could be calculated.

Once the biodegradable plant surround 10 has degraded, and due to the presence of carbonyl groups, it will enter into a biodegradation phase. Microorganisms commonly found in the environment, will feed off of the oxidized polymer chain to further reduce the material into CO₂, water and biomass (humus). The CO₂ is commonly used as fuel for further microbial growth and the carbon residue acts as a fertilizer for the plant.

The following standards were used during the testing regime: ASTM (American Society for Testing and Materials) D6954-04 Standard Guide for Exposing and Testing Plastics that Degrade in the Environment; ASTM D5510-94 (2001) Standard Practice for Heat Aging of Oxidatively Degradable Plastics; ASTM D5208-01 Standard Practice for UV Exposure; ASTM D3826-98 (2001) Standard Practice for Determining Degradation End Point; ASTM D882-09 Standard Test Method for Tensile Properties.

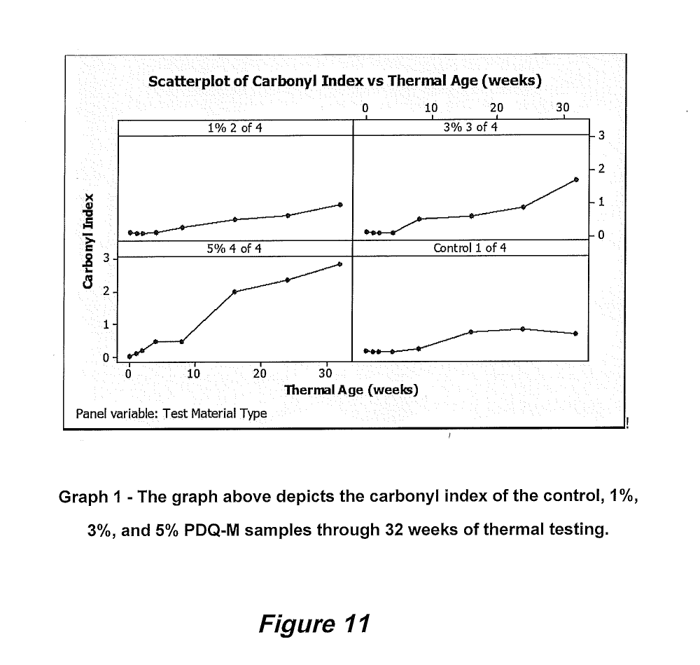

Samples of the biodegradable plant surround 10 were cut and placed at accelerated storage conditions (ASTM D5510 and ASTM 5208). Fourier transform infrared spectroscopy (FT-IR) analysis was conducted at the most relevant data points to chemically examine for the presence of oxidation (carbonyl C═O groups), the results of which are highlighted in FIG. 11.

Without the presence of the carbonyl groups, a plastic product that has degraded will not be able to biodegrade. In the present case once the material becomes brittle, it can be readily affected by microbial action. This signifies the beginning the second active phase-biodegradation.

Thermal testing helps to determine the usable shelf life cycle of a biodegradable plastic product. By determining what the shelf life will be at a known concentration, it can be determined the life cycle for almost any concentration of WRP additive through data analysis.

### Test Results

TABLE 1
Pro Oxidant Purity Testing

| | Plant Surround | | | |
|---|---|---|---|---|
| Trial Run | Control | 1% PDQ-M | 3% PDQ-M | 5% PDQ-M |
| 1 | 0.00% | 3.87% | 8.20% | 9.41% |
| 2 | 0.00% | 3.28% | 7.80% | 9.34% |
| 3 | 0.00% | 3.09% | 7.49% | 9.03% |
| Average PDQ-M | 0.00% | 3.41% | 7.83% | 9.26% |
| Percentage | | | | |

The Pro Oxidant Purity Testing undertaken on behalf of the Applicant entailed the testing of four plastic samples from the Applicant. The results in table 1 indicate that PDQ-M was not detected in the Control samples, but was detected in the other three samples. For all four sets of samples, three samples were taken from the biodegradable plant surround 10 and were tested three times for a total of 36 tests. The concentrations varied to a small degree in the PDQ-M samples, but the results were generally uniform. All concentrations observed in testing would allow oxo-biodegradation to occur in these samples.

The results show that the concentration of PDQ-M in the 1% samples is actually at 3.41%. The concentration level of the 3% samples was actually around 7.83%. Finally, the 5% samples were actually around 9.26%. Although the actual concentrations were higher when compared to the expected concentration, the results nevertheless provided comparative data.

The plant surround made with PDQ-M showed oxo-biodegradation results after going through accelerated thermal testing. The samples were allowed to go through testing for 32 weeks. The lowest concentrated PDQ-M samples did not show any physical signs of degradation over the course of testing. However, chemical analysis through FT-IR did show there was significant change happening when compared to the control samples, which showed minimal change.

The intermediate concentrated PDQ-M samples showed physical changes to the product after 24 weeks of accelerated thermal exposure. This was supported through chemical analysis of the samples that showed significant changes to the chemical structure at the time of physical property loss.

The highest concentrated PDQ-M samples showed physical change starting around 16 weeks. The outer most layer began to show weakening and flaking during the 16-week examination. Chemical testing also showed a significant difference between control and PDQ-M samples.

The biodegradable plant surround 10 with PDQ-M concentrated at 8.00% or higher are expected to have a usable life of around 24 months (2 years). A biodegradable plant surround 10 with a concentration of 7.00% are expected to have a usable life of around 32 months (approx. 2.6 years), and a biodegradable plant surround 10 with a concentration of 3.00% PDQ-M are expected to have a usable life of around 72 months (6 years). Other concentrations and usable lifespans of the biodegradable plant surround 10 are possible and fall within the scope of the present invention.

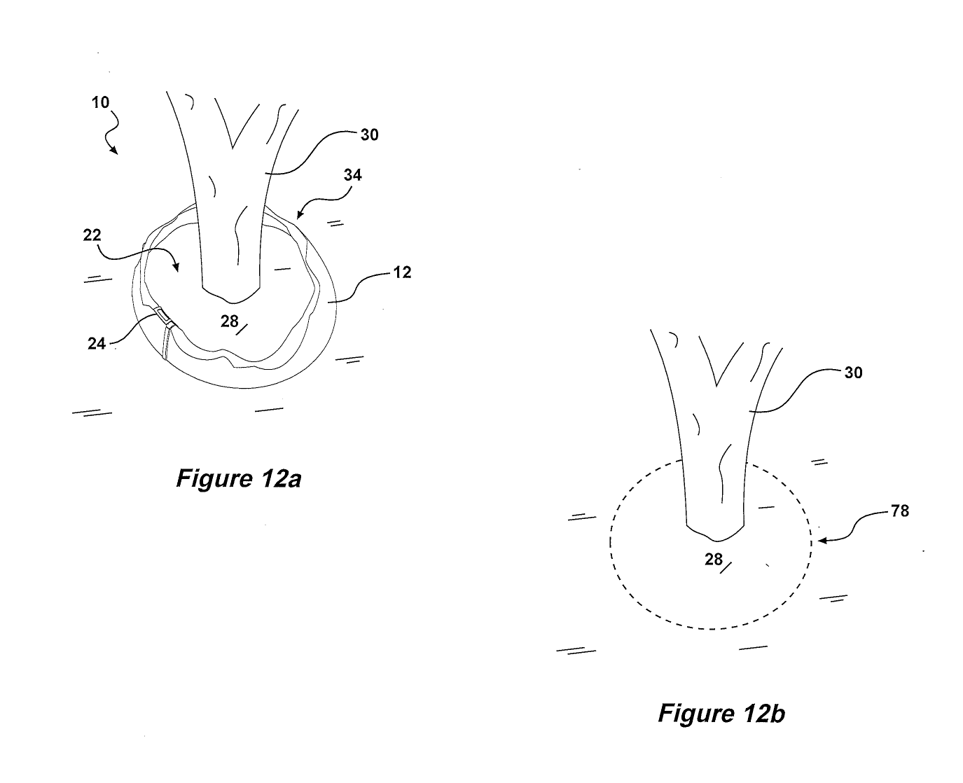

As illustrated in FIGS. 12a and 12b the biodegradable plant surround 10 is able to breakdown over a predetermined period of time to make it unnecessary to remove the plant surround at the end of its usable life or when the plant is sufficiently established that is no longer requires a water retaining surround. FIG. 12a illustrates the biodegradable plant surround 10 breaking down in situ, while FIG. 12b indicates the original position shown by broken line 78 once the biodegradation has occurred.

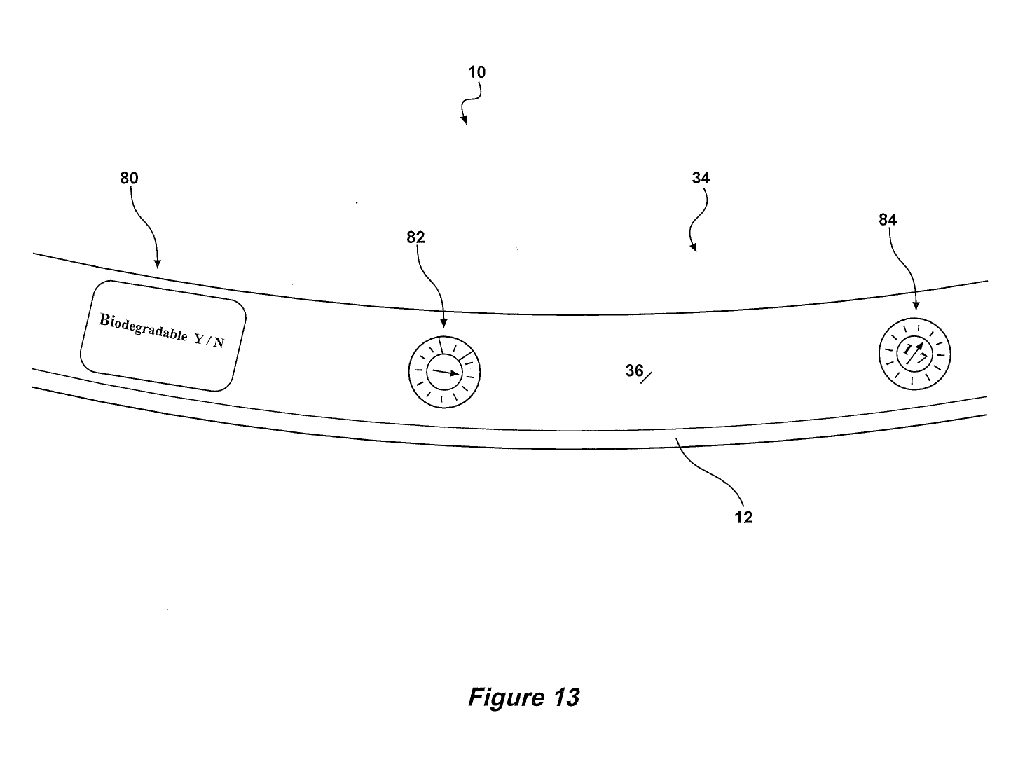

As illustrated in FIG. 13 the top may include indicia 80, 82 and 84 that indicate whether the plant surround 10 is biodegradable or non-biodegradable, the time or date of manufacture and the period of time over which the plant surround 10 will biodegrade. For instance, the indicia 82 may include the number of years over which the plant surround 10 will biodegrade and the indicia 84 may include the year of manufacture, indicated as ‘17’ in FIG. 13 for the year 2017, and the month of manufacture indicated by the arrow that points to the corresponding month.

The illustrated invention provides advantages over the prior art and each of the proposed embodiments is configured to overcome or ameliorate at least some of the problems identified in the prior art.

The embodiment that includes a locking member inhibits the opposing ends of the body 12 disengaging either partially or fully, which would affect the water retaining capacity of the plant surround 10 or create a tripping hazard. The embodiment that includes the irrigation hose engagement members means that the irrigation hose is held in place and inhibited from being disengaged from the plant surround 10.

The embodiment that is biodegradable means that the plant surround will begin to break down visibly and become food for microorganisms within the environment and therefore the removal of the plant surround from around the tree is unnecessary since degradation or biodegradation will occur. This is particularly relevant where government agencies and councils use the plant surrounds of the present invention in the establishment of street trees. In such situations there are cost savings, since the plant surrounds do not have to be manually removed once the street trees have been established.

Various features of the invention have been particularly shown and described in connection with the exemplified embodiments of the invention, however it must be understood that these particular arrangements merely illustrate the invention and it is not limited thereto. Accordingly, the invention can include various modifications, which fall within the spirit and scope of the invention.

1. A plant surround for forming a water retaining barrier around a plant, comprising:
a curved generally elongate body having opposing ends including cooperating engagement members that are configured to reversibly engage to thereby delineate said water retaining barrier; and
a locking member attached to said elongate body and configured to inhibit complete or partial disengagement of said opposing ends of the body.

2. The plant surround according to claim 1, wherein the opposing ends of the elongate body are slidable along respective longitudinal alignment to affect an interconnecting joining between said opposing ends to thereby form said water retaining barrier, the opposing ends being slidable relative to each other in a first direction to affect connection, and slidable relative to each other in a second direction being opposite to said first direction to disconnect said opposing ends to enable the placement or removal of the plant surround around said plant.

3. The plant surround according to claim 2, wherein a first of said opposing end of the elongate body include a protrusion to terminate movement of said opposing ends in said first direction, to thereby locate adjacent portions of an upper edge of each of the opposing ends generally along the same horizontal plane, whereby when the adjacent portions of the upper edge of the body are positioned along the same horizontal plane the opposing ends are located in a fully engaged position.

4. The plant surround according to claim 3, wherein the locking member inhibits said opposing ends from moving in said second direction relative to each other out of said fully engaged position.

5. The plant surround according to claim 4, wherein the locking member slidably engages an upper edge of the elongate body along an axis that is perpendicular to the longitudinal alignment of the cooperating opposing ends.

6. The plant surround according to claim 3, wherein the locking member preferably engages a lip that extends circumferentially around said upper edge of the body.

7. The plant surround according to claim 1, wherein the locking member is moved from an unlocked position where it is at a distance from a longitudinal axis of the cooperating opposing ends, and a locked position wherein the locking member intersects said longitudinal axis to thereby inhibit the cooperating opposing ends from disengaging.

8. The plant surround according to claim 7, wherein the locking member is generally curved to conform to the shape of the elongate body and the upper edge of the elongate body includes a raised portion to frictionally engage the locking member when in the locked position to inhibit the unintentional movement of the locking member out of said locked position.

9. The plant surround according to claim 1, wherein the locking member is detachably connected to the body by a spline prior to installation of the plant surround around a tree or plant.

10. The plant surround according to claim 1, wherein a lower edge of the elongate body is configured to engage a soil body in which the plant is located, and the upper edge of the body extends above a soil surface, wherein an outer surface of the elongate body includes markings to indicate the depth to which said elongate body should be buried in said soil body.

11. The plant surround according to claim 1, wherein an inner surface of the elongate body includes ridges or groove to inhibit girdling of roots of the plant when the plant surround is positioned within a soil body.

12. The plant surround according to claim 3, wherein a tab extends inwardly of said upper edge of the body of the plant surround, the tab including an aperture or slot for reversibly holding an irrigation hose therein.

13. The plant surround according to claim 12, wherein separates tabs are positioned on opposite sides of the plant surround whereby the irrigation hose can be secured to a respective tab as the irrigation hose enters and exists a void created by the elongate body.

14. A plant surround for forming a water retaining barrier around a plant, comprising:
a main body comprising a plurality of body portions joinable to delineate a water retaining barrier that extends around said plant, the plurality of body portions each having respective opposing ends including engagement members for connection to an adjacent body portion of said plurality of body portions; and
a plurality of locking members attached to said plant surround and configured to inhibit complete or partial disengagement of said opposing ends of said adjacent body portions, wherein a single locking member of said plurality of locking members is located at each junction of said plurality of body portions.

15. A mould for forming a plastic discontinuous plant surround in accordance with claim 1 having opposing end for interlocking to provide a water retaining barrier.

16. The plant surround according to claim 1, wherein the elongate body and locking member, or the plurality of body portions and locking members, are constructed from a biodegradable material.

17. The plant surround according to claim 16, wherein the biodegradable material has a known life span range within an environment, wherein after a predetermined period of time the plant surround will degrade or breakdown within the environment.

18. The plant surround according to claim 17, wherein the predetermined period of time may be within a range of months or years.

19. The plant surround according to claim 17, wherein the predetermined period of time may be selected from a group including: 2 years, 2.5 years, 3 years, 3.5 years, 4 year, 4.5 years, 5 years, 5.5 years, 6 years, and 6.5 years.

20. The plant surround according to claim 16, wherein the elongate body or plurality of body portions includes indicia to indicate the time or date of manufacture and the period of time over which the plant surround will degrade or breakdown within the environment.
